(19) United States
(12) Patent Application Publication
(10) Pub. No.: US 2015/0047192 A1
(43) Pub. Date: Feb. 19, 2015

(54) METHOD TO INSTALL A ROTOR BLADE

(71) Applicant: SIEMENS AKTIENGESELLSCHAFT, MUNCHEN (DE)

(72) Inventor: HENNING EBBESEN, SKJERN (DK)

(21) Appl. No.: 14/312,779

(22) Filed: Jun. 24, 2014

(30) Foreign Application Priority Data
Aug. 14, 2013 (EP) 13180367.8

(51) Int. Cl. F03D 1/00

(52) U.S. Cl. CPC F03D 1/001
USPC 29/889.3

(57) ABSTRACT

A method to install rotor blades at a wind turbine is provided. A method to install a rotor of a wind turbine at a nacelle of a wind turbine comprises the step of connecting at least a first rotor blade to a first segment of a hub for transportation and/or installation purposes.

### CROSS-REFERENCE TO RELATED APPLICATIONS

This application claims priority to EP Application No. 13180367.8, having a filing date of Aug. 14, 2013, the entire contents of which are hereby incorporated by reference.

### FIELD OF TECHNOLOGY

The following relates to a method to install a rotor blade at a wind turbine.

### BACKGROUND

A wind turbine comprises a nacelle that is arranged on top of a tower. A rotor is attached to the nacelle that comprises a rotor hub and a plurality of rotor blades. During the installation of the wind turbine, the nacelle is arranged on top of the tower. Then, the rotor hub and the rotor blades need to be attached to the nacelle. Often the rotor blades are connected to the hub at ground level and are then hoisted up to the nacelle and connected to the nacelle as one piece. Thus, a crane needs one turn to lift up the rotor of the wind turbine. As the wind turbines get more powerful, the rotor blades are constructed longer and heavier.

Therefore, it is known to mount the hub to the nacelle and thereafter lift the rotor blades up to the hub, one after the other. The connection between the rotor blades and the hub is then established in the working height of the hub. For this mounting method, a crane needs four turns to lift up the pieces to form the rotor hub. In addition, time is needed to establish the connection between the rotor blades and the hub. Thus, the installation takes longer.

Therefore, a need exists to provide an improved method to install the rotor of a wind turbine.

### SUMMARY

An aspect relates to a method to install a rotor of a wind turbine at a nacelle of a wind turbine, comprising the step of connecting at least a first rotor blade to a first segment of a hub for transportation and/or installation purposes. During the installation of the wind turbine, a rotor is connected to the nacelle of the wind turbine. The rotor of the wind turbine comprises a rotor hub and rotor blades. The rotor blades are connected to the rotor hub and the rotor hub is connected rotatable to the nacelle of the wind turbine. The hub of the rotor can be segmented and each segment of the hub may comprise a connection area to connect a rotor blade to the segment of the hub.

A first rotor blade can be connected to a first segment of the hub. A rotor blade may be connected to a hub in a way that a pitch angle of the rotor blade with respect to the hub can be regulated and controlled. Thus, the connection between the rotor blade and the hub comprises a mechanical connection using a bearing. An electric or hydraulic component may be needed to adjust and control the pitch angle of the rotor blade. Each segment of the hub may comprise its electric or hydraulic component to regulate the pitch angle. In addition, the segment of the hub may comprise the bearing that allows the pitch movement of the rotor blade during the operation of the wind turbine.

The rotor blade can be connected to the segment of the hub before the hub is connected to the nacelle of the wind turbine. Thus, the connection between the rotor blade and the segment of the hub can be performed at ground level at the installation site of the wind turbine. The connection between the rotor blade and the segment of the hub can also be performed at a remote location, for example, at the production site of the wind turbine blade. The installation can be performed, for example, within a building, where a rotor blade and a hub segment are protected from environmental and meteorological influences. Thus, wind, rain and cold temperatures may not influence the establishment of the connection between the rotor blade and the hub segment.

The connection between the rotor blade and the hub segment can be established on ground level and the installation personnel performing the connection do not have to work at hub height of the wind turbine. Thus, the connection can be established more easily and safer. In addition, the connection and the function of the pitch system of the rotor blade can be tested at ground level. The connection can be established at the production site where all tools and test systems necessary are available. The rotor blade and the hub segment that are connected together can then be transported to the installation site of the wind turbine.

Embodiments of the method may comprise the steps of hoisting at least a first segment of the hub together with the first rotor blade up to a nacelle of a wind turbine and connecting at least the first segment of the hub to the nacelle of the wind turbine.

A segment of a hub can be connected to a rotor blade. The rotor blade together with the segment of the hub may be hoisted up towards the nacelle of the wind turbine. The nacelle of the wind turbine is installed on top of the tower. The segment of the hub is then connected to the nacelle of the wind turbine. Thus, the rotor blade connected to the segment of the hub is then installed at the wind turbine.

A single rotor blade connected to the segment of the hub is more light weight then a complete rotor of a wind turbine including the hub and all rotor blades. Thus, less weight has to be lifted up to the nacelle of the wind turbine, and a smaller crane can be used to lift up the rotor blade and the segment of the hub. In addition, a single rotor blade with a segment of a hub comprises less area that can interact with the wind at the installation site of the wind turbine. Thus, the single rotor blade with a segment of the hub is easier to install at the nacelle of the wind turbine.

Embodiments of the method may comprise the steps of connecting a second rotor blade to a second segment of the hub. The second rotor blade and the second segment of the hub may be hoisted up to nacelle of the wind turbine. The second segment of the hub can be connected to the nacelle of the wind turbine and to the first segment of the hub. Thus, the other rotor blades necessary to establish the rotor of a wind turbine can be connected to one of the respective segments of the hub.

This connection can also be performed at a production site or on ground level at the installation site of the wind turbine. When the connection is established at a production site, the rotor blades and the segments of the hub that are connected together are transported to the installation site of the wind turbine.

Furthermore, a second rotor blade that is connected to a second segment of the hub may be hoisted up to the nacelle of the wind turbine. There, the second segment of the hub can be connected to the nacelle of the wind turbine. In addition, the connection to the first segment of the hub is established. In many embodiments, wind turbines comprise three rotor blades. Thus, three single rotor blades connected to a segment of a hub each may be lifted up towards the nacelle of the wind turbine and are connected to the nacelle and to each other. The rotor of the wind turbine can be established at their installation site up at a nacelle at a wind turbine. Thus, the single rotor blades and the segments of the hub are more light weight then the complete rotor of the wind turbine; a smaller crane is needed.

In addition, the rotor blade and the segment of the hub may show a smaller area to interact with the wind during the installation at the wind turbine. Thus, the installation of the segment of the hub together with the rotor blade can be easier to perform than the installation of a complete rotor of the wind turbine.

Embodiments of the method may also comprise the step of establishing an electric and/or a hydraulic connection between the first segment of the hub and the second segment of the hub to connect an electric or a hydraulic system within the hub. An electric and/or a hydraulic system can be present in the hub of the wind turbine. This system can, for example, be a pitch system to change and control the pitch angle of the rotor blade with respect to the hub of the wind turbine. A segment of a hub can be connected to a rotor blade. A pitch system can be installed in a segment of a hub. In one exemplary embodiment, at least two segments of a hub form a hub of the wind turbine. However, other embodiments may include a plurality of hub segments, such as three or more.

The segments of the hub together with the rotor blades attached to the segment of the hub can be hoisted up towards the nacelle of the wind turbine and can be connected to the nacelle of the wind turbine. After the segments of the hub are connected to the nacelle of the wind turbine and are connected together, a connection of the electric and/or the hydraulic components in the segments of the hub may be established. Thus, the electric and/or hydraulic systems in the hub of the wind turbine are connected and can be controlled together.

Embodiments of the method may comprise the step of establishing an electric and/or a hydraulic connection between at least one segment of the hub and the nacelle of the wind turbine. An electric and/or a hydraulic system within the hub of the wind turbine can, for example, be a pitch system, to vary the angle of the rotor blades in respect to the hub of the wind turbine.

The segments of the hub can be connected to the nacelle to form a hub of the wind turbine. The hub of the wind turbine may be rotatably connected with respect to the nacelle of the wind turbine. For example, a rotary unit may be used to establish the rotatable connection. A connection between the electric and/or hydraulic system within the nacelle of the wind turbine into the hub of the wind turbine may be established. Thus, electrical and/or hydraulically systems or components within the hub of the wind turbine can be controlled and operated from the nacelle of the wind turbine.

Embodiments of the method may comprise the steps of connecting a first rotor blade to a first segment of a hub and connecting a second rotor blade to a segment second of the hub. In an exemplary embodiment, at least the first segment of the hub and the second segment of the hub are connected.

Embodiments of the method may further comprise the steps of hoisting at least two segments up to the nacelle of the wind turbine and connecting the segments to the nacelle of the wind turbine.

A rotor of a wind turbine comprises rotor blades and a hub. A rotor blade is connected to a segment of a hub to form a segment of a rotor of the wind turbine. The connection between the rotor blade and the segment of the hub can be performed on ground level at the installation site of the wind turbine. The connection can also be established at a production site, for example, the production site of the rotor blade. There, the installation can be performed within a building independently from environmental or weather conditions. The rotor blade together with the segment of the hub can then be transported to the installation site of the wind turbine.

The at least two segments of the hub may be connected on ground level at the installation site of the wind turbine. Thus, the segments of the hub together with the rotor blades may be connected together to form at least a part of the rotor of the wind turbine. The at least two segments of the hub that are connected together may be hoisted up towards the nacelle of the wind turbine and are connected to the nacelle. Thus, at least a part of the rotor of the wind turbine comprising at least two segments of the hub may be installed at the nacelle of the wind turbine, and the connection between the segment of the hub and the rotor blade can be performed at a location that is independent from the installation site of the wind turbine.

The segments of the rotor can be tested, for example, at the production site of the rotor blade of the wind turbine. The segments of the hub together with the rotor blades can then be transported to the installation site of the wind turbine and can be connected to each other at the installation site. In addition, any electric or hydraulic connection between the segments of the hub can be established on the ground level at the installation site of the wind turbine. Thus, the personnel establishing the connection can work on ground level, increasing the safety for the installation personnel.

Furthermore, at least two segments of the hub that are connected together, or the complete rotor of the wind turbine, may be hoisted up towards the nacelle of the wind turbine. There, the connection to the nacelle of the wind turbine is established. The crane to lift up the rotor towards the nacelle of the wind turbine may be only needed for one lifting operation. Thus, the crane time for the crane capable of lifting up the rotor to the nacelle of the wind turbine can be minimized, and the installation costs of the rotor of the wind turbine can be reduced.

### BRIEF DESCRIPTION

Some of the embodiments will be described in detail, with reference to the following figures, wherein like designations denote like members, wherein:

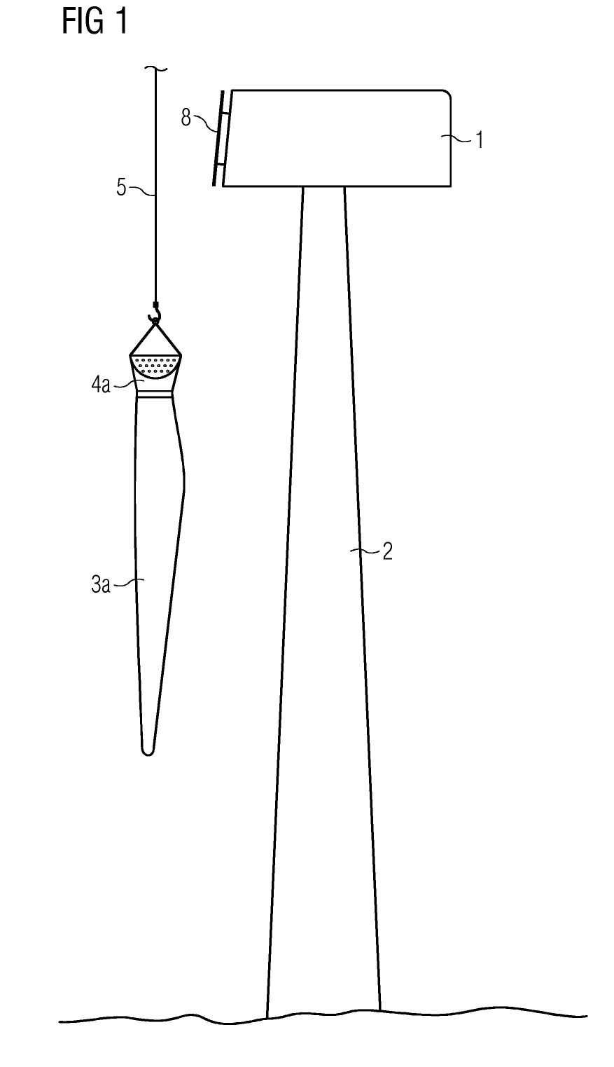

FIG. 1 shows an embodiment of a wind turbine during the installation of a rotor blade;

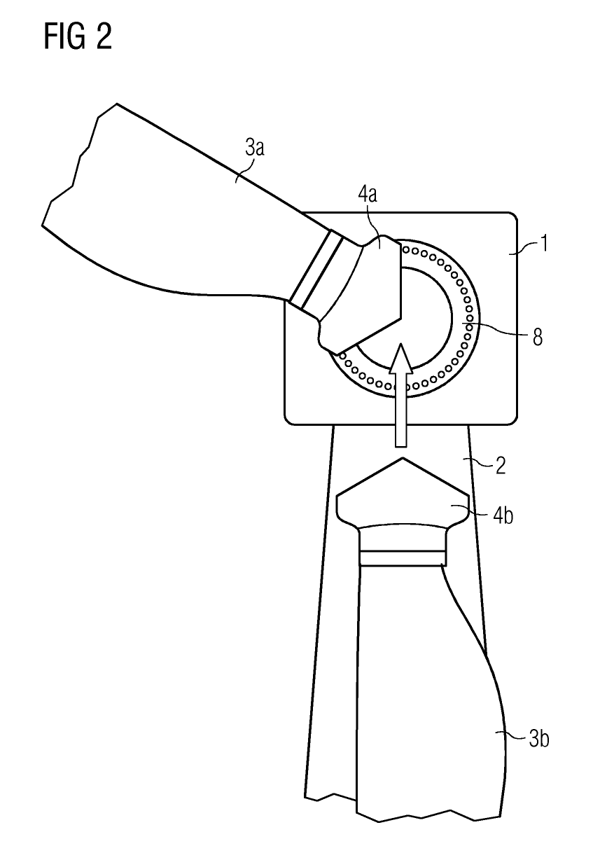

FIG. 2 shows an embodiment of the installation of a second rotor blade at a wind turbine;

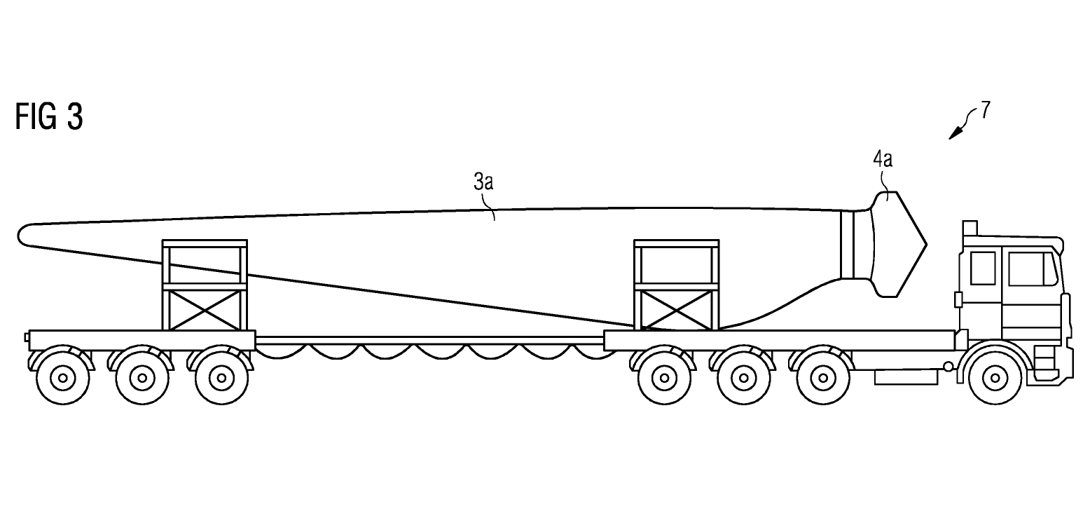

FIG. 3 shows a transportation of a rotor blade; and

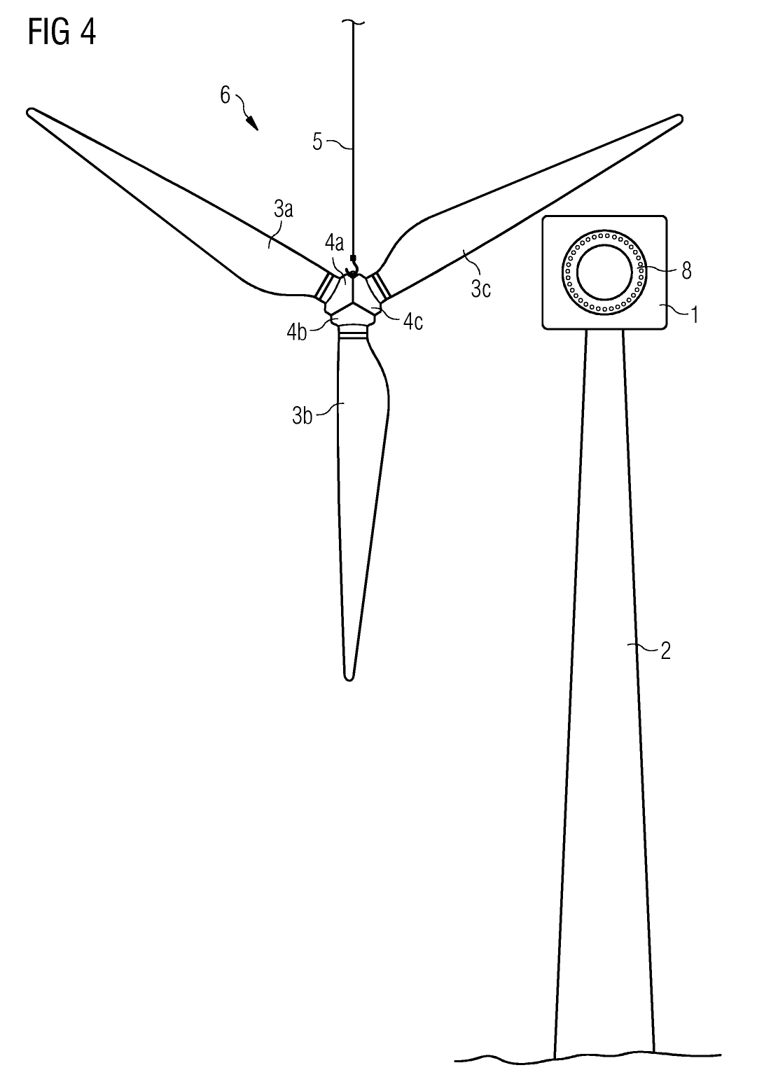

FIG. 4 shows an embodiment of the installation of a rotor at a wind turbine.

### DETAILED DESCRIPTION

FIG. 1 shows a wind turbine during the installation of a rotor blade. The wind turbine comprises a nacelle 1 and a tower 2. The nacelle 1 comprises an area 8 to connect the hub of the wind turbine to the nacelle 1. A first rotor blade 3a is connected to a first segment of the hub 4a. The first rotor blade 3a together with the first segment of the hub 4a is hoisted up towards the nacelle 1 by a crane 5. After, the first rotor blade 3a together with the first segment hub 4a is hoisted up towards the nacelle 1. The first segment of the hub 4a is connected to the connection area 8.

FIG. 2 shows the installation of a second rotor blade at a wind turbine. The wind turbine comprises a nacelle 1 that is arranged in the top of the tower 2. The nacelle 1 comprises an area 8 to connect the hub of the wind turbine to the nacelle 1.

A first rotor blade 3a together with a first segment of the hub 4a is connected to the connection area 8. A second rotor blade 3b is connected to a second segment of the hub 4b. A second rotor blade 3b together with the second segment of the hub 4b is hoisted up towards the nacelle 1 to be connected at a connection area 8. The second segment of the hub 4b is then connected to the connection area 8 and to the first segment of the hub 4a.

FIG. 3 shows the transportation of a first rotor blade 3a together with the first segment of the hub 4a. The first segment of the hub 4a is connected to the first rotor blade 3a.

The first rotor blade 3a together with the first segment of the hub 4a is arranged on the transportation vehicle 7. A rotor blade together with the segment of the hub is transported as a pre-mounted unit to the erection side of the wind turbine.

FIG. 4 shows the installation of a rotor at a wind turbine. The rotor of the wind turbine comprises a hub 6 and a plurality of rotor blades 3. The hub 6 is built of three segments of a hub 4a, 4b and 4c; however, embodiments of the hub 6 may be built of less than three segments or more than three segments, for example, a plurality of segments. The plurality of rotor blades 3 may include three rotor blades 3a, 3b, 3c connected to one segment of the hub 6 each. The wind turbine comprises a nacelle 1 that is arranged on top of the tower 2. The nacelle 1 comprises an area 8 to connect the rotor to the nacelle 1.

The first rotor blade 3a is connected to a first segment of the hub 4a. A second rotor blade 3b is connected to a second segment of the hub 4b and a third rotor blade 3c is connected to a third segment of the hub 4c.

The three segments 4a, 4b, 4c of the hub 6 are connected together to form the hub 6 at a ground level. Thus, the rotor of the wind turbine comprising the three rotor blades 3a, 3b, 3c and the hub 6 with the segments 4a, 4b, 4c is pre-mounted on the ground before it is hoisted up to the nacelle 1 of the wind turbine.

A crane 5 is connected to the hub 6 to lift-up the rotor of the wind turbine towards the connection area 8 of the nacelle 1.

The illustration in the drawings is in schematic form. It is noted that in different figures, similar or identical elements are provided with the same reference signs.

Although the present invention has been described in detail with reference to exemplary embodiments, it is to be understood that the present invention is not limited by the disclosed examples, and that numerous additional modifications and variations could be made thereto by a person skilled in the art without departing from the scope of the invention.

It should be noted that the use of “a” or “an” throughout this application do not exclude a plurality, and “comprising” does not exclude other steps or elements. Also elements described in association with different embodiments may be combined. It should also be noted that reference signs in the claims should not be construed as limiting the scope of the claims.

1. A method to install a rotor of a wind turbine at a nacelle of the wind turbine, comprising:
connecting at least a first rotor blade to a first segment of a hub for transportation and/or installation purposes.

2. The method according to claim 1, comprising:
hoisting at least the first segment of the hub together with the first rotor blade up to the nacelle of the wind turbine; and
connecting at least the first segment of the hub to the nacelle of the wind turbine.

3. The method according to claim 1, comprising:
connecting a second rotor blade to a second segment of the hub;
hoisting up the second rotor blade and the second segment of the hub to the nacelle of the wind turbine; and
connecting the second segment of the hub to the nacelle of the wind turbine and to the first segment of the hub.

4. The method according to claim 3, comprising:
establishing an electric and/or a hydraulic connection between the first segment of the hub and the second segment of the hub, to connect an electric or a hydraulic system within the hub.

5. The method according to claim 3, comprising:
establishing an electric and/or a hydraulic connection between at least one segment of the hub and the nacelle of the wind turbine.

6. The method according to claim 2, comprising:
connecting the first rotor blade to the first segment of a hub;
connecting a second rotor blade to a second segment of the hub;
connecting at least the first segment of the hub and the second segment of the hub;
hoisting the first segment and the second segment up to the nacelle of the wind turbine; and
connecting the first segment and the second segment to the nacelle of the wind turbine.
